(19) United States
(12) Patent Application Publication
(10) Pub. No.: US 2011/0113584 A1
(43) Pub. Date: May 19, 2011

(54) COMPOSITE WIPER ARM

(75) Inventors: Eckart Wunsch, Unterreichenbach (DE); Filip Verhoeve, Moen (BE)

(73) Assignee: NV BEKAERT SA

(21) Appl. No.: 13/003,386

(22) PCT Filed: May 26, 2009
(86) PCT No.: PCT/EP09/56351

§ 371 Date: Jan. 10, 2011

(30) Foreign Application Priority Data
Jul. 22, 2008 (EP) 08160849.9

(51) Int. Cl. B60S 1/40; B23P 17/04

(52) U.S. Cl. 15/250.32; 29/428

(57) ABSTRACT

A wiper arm (10) for a windshield wiper (100) is described. The wiper arm (10) comprises a first end section (12) arranged to be coupled to a drive shaft of a driving means for driving the wiper arm (10) and a second end section (14) arranged to be coupled to a wiper blade (230). Extending between said end sections (12, 14) an elongate intermediate section (16) is provided. The intermediate section (16) comprises an internal structure covered by a matrix (20). The internal structure comprises at least one structural member (18) of a single high-tensile strength material.

### FIELD OF THE INVENTION

The present invention relates to a wiper arm for a windshield wiper, comprising a first end section arranged to be coupled to a drive shaft of a driving means for driving the wiper arm, a second end section arranged to be coupled to a wiper blade, and an elongate intermediate section extending between said first end section and said second end section, said intermediate section comprising a structural member surrounded by a matrix material. The present invention further relates to a method of making a wiper arm.

### BACKGROUND OF THE INVENTION

A wiper arm for a windshield wiper is for example known from the international patent application WO 2007/003261. The known wiper arm comprises a longitudinal central web which is covered by an outer sleeve. The longitudinal central web comprises a multilayer plate or structural member made of superimposed layers of different materials and/or thickness, in particular the central web is made of a composite material based on glass fibres and/or carbon fibres. In addition to the layers of composite material the central web may also comprise a layer of metal. The use of a composite material provides the wiper arm with good mechanical properties such as strength and rigidity.

The known wiper arm, due to the specific construction of the central web of composite material, is of a complex design and consequently is difficult and expensive to produce.

### OBJECT OF THE INVENTION

An object of the invention is therefore to simplify the design of the known wiper arm while at least maintaining the required mechanical properties thereof.

### SUMMARY OF THE INVENTION

According to an aspect of the invention this object is achieved by a wiper arm for a windshield wiper, comprising a first end section arranged to be coupled to a drive shaft of a driving means for driving the wiper arm, a second end section arranged to be coupled to a wiper blade, and an elongate intermediate section extending between said first end section and said second end section, said intermediate section comprising a structural member surrounded by a matrix material, wherein said structural member consists of a single high-tensile strength material.

The inventors have realized that it is possible to provide a wiper arm for a windshield wiper that has at least similar mechanical properties and in some aspects even superior mechanical properties as the known wiper arm without providing the wiper arm with a central web of a composite material. In fact, the inventors have realized that the use of high-tensile strength material will provide a wiper arm that has at least similar mechanical properties as the composite material comprising wiper arm, such as strength and flexibility, but at the same time will drastically simply it manufacturing and associated costs.

In an embodiment according to the invention the intermediate section comprises two or more structural members each consisting of a single high-tensile strength material. This will allows to change the mechanical properties of the wiper arm to account for specific requirements such as rigidity, weight balance etc.

In a further embodiment according to the invention the high-tensile strength material is chosen from a group of materials having a tensile strength of larger than 1000 MPa, in particular more than 1500 MPa, more in particular more than 1800 MPa. These values of the tensile strength have proven to be particularly suitable in providing a wiper arm that has excellent mechanical properties.

In a further embodiment according to the invention the high-tensile strength material is a high-tensile steel composition. The use of high-tensile steel provides a wiper arm that can be made much lighter than the known wiper arms comprising composite central webbing. Furthermore, high-tensile steel compositions allow a much more simplified manufacturing method, reducing fabrication costs.

In a further and preferable embodiment of the invention the structural member is in the form of a wire, which is easy to produce and provides good flexibility to the wiper arm. The wire can be a hard drawn round wire, a hard drawn profile wire, or a rolled flat wire. The wire can also be a tempered martensitic wire.

In a further embodiment according to the invention the structural member is in the form of a sheet. In this manner mechanical properties such as flexibility of the wiper arm can be made different in different directions.

In a further embodiment of the invention the structural member is in the form of a tubular member. This allows a further reduction of weight of the wiper arm.

In a further embodiment of the invention the structural member is adapted to be connected to supply means for supplying cleaning fluid. The tubular member is used to transport cleaning.

In a further embodiment of the invention the structural member is provided with an anti-corrosion coating material, so as to provide a resistance against corrosion. Suitable anti-corrosion coating materials are chosen from a group consisting of zinc (Zn), zinc-aluminium (ZnAl), zinc-aluminium-magnesium (ZnALMg).

In a further embodiment of the invention the matrix comprises a plastic material, in particular a thermoplastic material, which is easy to handle and allows various cross-sectional shapes to be designed for the wiper arm. As a matter of example, the plastic material can be extruded around the structural member. The various cross-sectional shapes of the wiper arm are independent of the specific cross-section of the structural member.

In a further embodiment of the invention the structural member is provided with a primer contacting the matrix material, the primer being chosen from the group consisting of organo functional silanes, organo functional titanates and organo functional zirconates, which provide a strong bond between the material of the structural member and the material of the matrix, in particular when the material of the structural member is a high-tensile steel composition.

In a further embodiment of the invention the matrix is provided by extrusion moulding around the structural member, reducing production costs and providing a quick and secure means of producing a wiper arm according to the invention. Furthermore, this will protect the structural member from the environment.

In a further embodiment of the invention the wiper arm further comprises a spoiler integral with the matrix. A spoiler will guide an air flow across its surface, such that a force is exerted that pushed the wiper arm onto a windshield. As the matrix is extraction moulded or extruded around the structural member, its shape is can be freely chosen to a large extent and the spoiler can be conveniently provided in the same moulding step.

In a further aspect the invention is embodied in a windshield wiper comprising a wiper arm according to the invention.

In a further aspect of the invention a method of making a wiper arm for a windshield wiper is provided, the method comprising providing a structural member of a single high-tensile strength material, and surrounding the structural member by a matrix of a plastic material, in particular a thermoplastic material.

### BRIEF DESCRIPTION OF THE DRAWINGS

Further advantageous embodiments of the wiper arm and windshield wiper comprising such a wiper arm according to the invention are described in the claims and in the following description with reference to the drawing, in which:

FIG. 1 schematically shows a wiper arm according to the invention;

FIG. 2 shows a longitudinal sectional view of the wiper arm of FIG. 1;

FIG. 3A shows a cross-section of the wiper arm of FIG. 1;

FIG. 3B shows the wiper arm of FIG. 3 in cross-section with a spoiler;

FIG. 4 shows a three-dimensional view of a vehicle provided with windshield wiper according to the invention, and

FIG. 5A-5P show different embodiments of structural members of a wiper arm according to the invention.

### DETAILED DESCRIPTION OF EXAMPLES

Referring to FIGS. 1 and 4 a wiper arm 10 is shown which is part of a windshield wiper 100. Such a windshield wiper 100 is for example used for a vehicle 200 such as a car and is driven by a driving means, such as an electric motor, in an alternating way as indicated with reference numeral 220, to wipe precipitation or dirt of a windshield 210. The wiper arm 10 comprises a first end section 12 which is arranged to be coupled to a drive shaft of the driving means for driving the wiper arm 10 around the axis A. Coupling of the wiper arm 10 to said drive shaft is done in a way known per se to the person skilled in the art.

The wiper arm 10 further comprises a second end section 14 that is arranged to be coupled to a wiper blade 230. This can be effected in a number of ways known per se to the person skilled in the art.

Extending between the first end section 12 and the second end section 14 an elongate intermediate section 16 is provided, which connect both end sections 12, 14 to each other to form a unitary wiper arm 10. The connection between the intermediate section 16 and the first end section 12 may comprise a hinge part 30, however this is not required. The same applies to the way the second end section 14 can be coupled to the intermediate section 16, i.e. the second end section 14 may be connected to the intermediate section 16 by means of a hinge or hinging connection.

In an alternative embodiment (not shown), the wiper arm also comprises three separate parts: a first end section, an intermediate section and a second end section. The connections between the first end section and the intermediate section and between the intermediate section and the second end section are not hinging but are rigid. In this case, the structural member in the intermediate section has some spring properties and allows some deflection in a direction perpendicular to the window.

In still another alternative (not shown), the wiper arm is a single piece formed by the three parts: first end section, intermediate section and second end section.

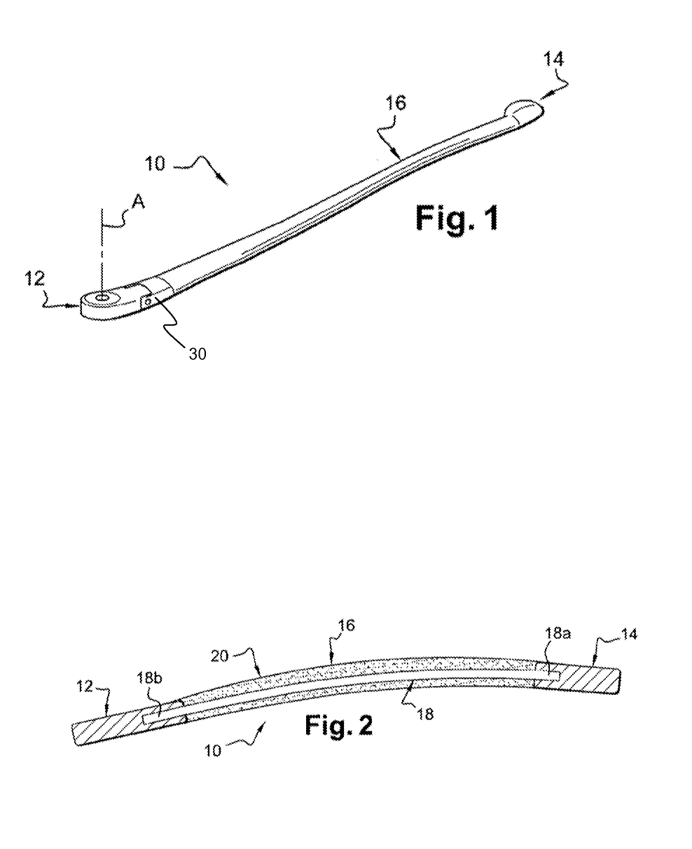

The intermediate section 16 comprises an elongate structural member 18. This is shown in FIG. 2, where a longitudinal sectional view is given of the wiper arm 10.

The structural member 18 is covered by an matrix material 20 made from an elastic material, in particular a (thermo-)plastic material. In the application of wiper arms for windshield wipers examples of suitable thermoplastic materials are: polyethylene (PE), polypropylene (PP), polystyrene (PS), polyethylene terephthalate (PET), polyethylene napthalate (PEN), polybuteen terephthalate (PBT) polyvinylchloride (PVC), polyamide (PA), polyester (PES), polyimide (PI), polycarbonate (PC), styrene acrilonitryl (SAN), acrylonitril-butadiene-styrene (ABS), thermoplastic polyurethane (TPU), thermoplastic polyolefins (TPO), thermoplastic copolyetheresters, copolymers of these polymers or similar materials.

The structural member 18 preferably is shaped as an elongate wire and is made from a single or monolithic high-tensile strength material, i.e. a non-composite material, which is chosen from a group of materials having a tensile strength of larger than 1000 MPa, in particular more than 1500 MPa, more in particular more than 1800 MPa. An example of such material is high-tensile steel. However, other materials having similar properties and in particular tensile strength may also be considered.

In case of high-tensile strength steel, a typical high-tensile steel wire composition has a minimum carbon content of 0.45%, a manganese content ranging from 0.40% to 0.70%, a silicon content ranging from 0.15% to 0.30%, a maximum sulfur content of 0.03%, a maximum phosphorus content of 0.30%, all percentages being percentages by weight.

Hence, a suitable steel composition for wires to be embedded in a wiper arm is along the following lines:
a carbon content ranging from 0.30% to 2.0%, e.g. from 0.5 to 1.2%; e.g. from 0.6 to 1.1%;
a silicon content ranging from 0.10% to 2.5%, e.g. from 0.15 to 1.60%;
a manganese content ranging from 0.10% to 2.0%, e.g. from 0.50 to 0.90%;
a chromium content ranging from 0.0% to 2.0%, e.g. from 0.10% to 1.50%; e.g. from 0.10% to 0.90%;
a vanadium content ranging from 0.0% to 2.0%, e.g. from 0.05% to 0.60%, e.g. from 0.10% to 0.50%;
a tungsten content ranging from 0.0% to 1.5%, e.g. from 0.1% to 0.70%.

In some compositions either chromium or vanadium is present. In some other compositions both chromium and vanadium are present. The amounts of sulfur and phosphorous are preferably kept as low as possible, e.g. both below 0.05%, e.g. below 0.025%.

The structural member or wire 18 has two opposite distal ends 18a, 18b which may, at least partly, extend into the respective end sections 12 and 14 and to which the distal ends 18a, 18b may be attached by means of gluing for example. However, in particular when the structural member 18 is made from a high-tensile steel material, other ways of attaching the end sections 12, 14 to the intermediate section 16 may be contemplated, such as welding or soldering. It is also conceivable to provide the distal ends 18a, 18b of the structural member 18 with a specially adapted shape.

In FIGS. 1 and 2 the first end section 12, the second end section 14 and the intermediate section 16 are shown to be separate, yet coupled elements. It is to be understood however that the respective sections 12, 14 and 16 can also be formed out of a single piece. Hence, the end sections 12 and 14 are integral with the intermediate section 16. Consequently, the use of the term section is not limited to separate elements, but merely indicated different identifiable parts of the wiper arm 10. This can for example be achieved by cold forming the distal ends 18a, 18b such that they can couple with the driving means and a wiper blade 230 (see FIG. 4) respectively.

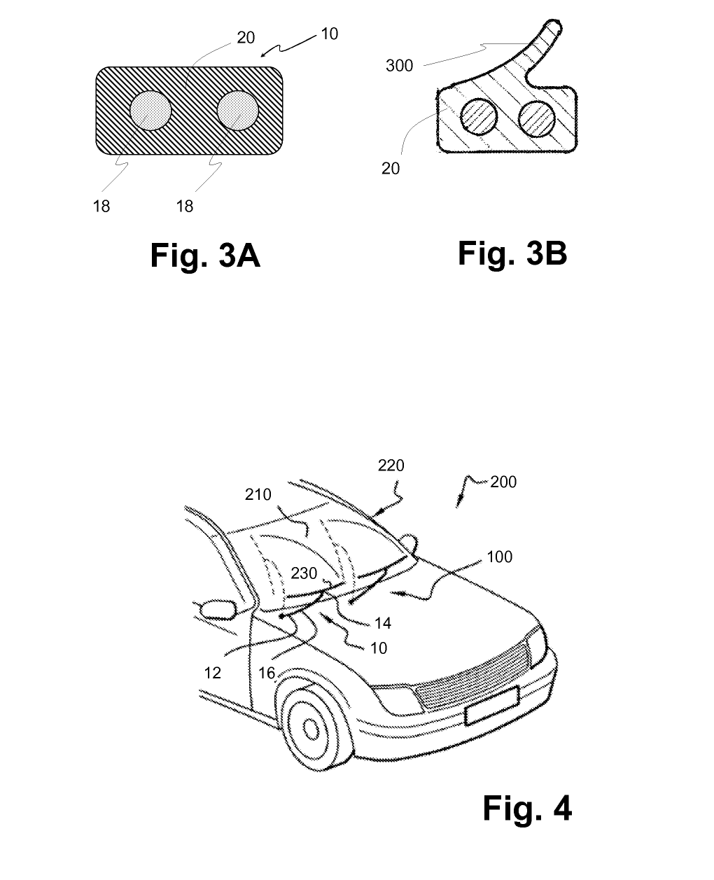

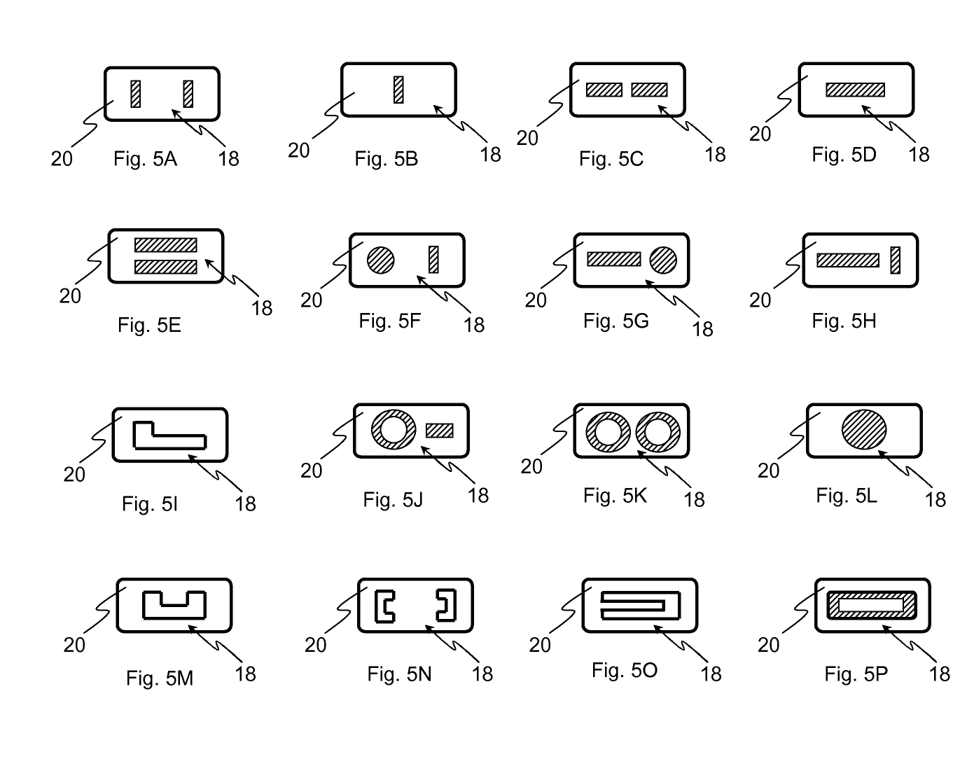

In the embodiment of FIG. 2, the wiper arm 10 comprises a single structural member or wire 18. It is however also possible to provide more than one, such as two structural members 18. This is shown in FIG. 3, wherein a cross-sectional view is given of the wiper arm 10. As can be seen in the Figure, two structural members or wires 18 are embedded in the material of the matrix 20. Both members 18 are shown to have a circular solid cross-section, but it is to be understood that other cross-sectional shapes are also possible, in particular polygonal cross-sections. Alternatively, the structural members can also be designed as tubular members. Furthermore, when multiple wires are used, these wires do not necessarily need to have the same cross-sectional shape, nor do they have to be made from the same high-tensile strength material. More examples of how the structural member(s) 18 may look like are given with reference to FIGS. 5A to 5P.

In a typical application of the invention in which two members or wires 18 are used, the wires have a diameter between 2 and 5 mm, in particular between 3 and 4 mm, and preferably about 3,5 mm.

It is noted that the cross-sectional shape of the wiper arm 10 does not necessarily need to be as shown in FIG. 3A, i.e. a rectangular cross-section. In fact, when using a thermoplastic material for the matrix 20, at least the intermediate section 16 can be made by extrusion moulding the thermoplastic material around the internal structure comprising the structural member(s) and can thus be provided with a large variety of cross-sectional shapes. In particular shapes can be thought of that reduce drag and consequently reduced sound generation when exposed to a flow of air. It is noted that the material of which the matrix 20 is made is not limited to a thermoplastic material. In fact, any suitable plastic material may be used, in particular a thermoset material.

In order to provide a resistance against corrosion and/or to promote the adhesion with the thermoplastic material of the matrix, in case the matrix is made of such thermoplastic material, the structural member or members 18 may be provided with a coating material. Such a coating can for example be zinc.

An alternative coating can be a zinc aluminium (ZnAl) coating. A ZnAl coating may for example have an aluminium content ranging from 2 percent by weight to 12 percent by weight, e.g. ranging from 3% to 11%, with a preferable composition around the eutectoid position: Al about 5 percent. The zinc alloy coating may further comprise a wetting agent such as lanthanum or cerium in an amount less than 0.1 percent of the zinc alloy. The remainder of the coating is normally zinc and unavoidable impurities.

Alternatively, compositions with about 10% aluminium are also possible. Compared to the zinc-only coating, the zinc aluminium coating shows a better overall corrosion resistance and is more temperature resistant. Furthermore, there is no flaking with the zinc aluminium coating when exposed to high temperatures.

Alternatively, magnesium can also be added up to 2 weight percent to form a ZnAlMg alloy.

In the event that the matrix 20 is made from one of the mentioned thermoplastic materials and the structural member(s) 18 is made from high-tensile strength steel, the structural member 18 may be provided with a primer to promote adhesion to the thermoplastic matrix.

Such a primer is preferably selected from a group comprising organo functional silanes, organo functional titanates and organo functional zirconates. Preferably, but not exclusively, the organo functional silane primers are selected from the compounds of the following formula:

Y—(CH₂)ₙ—SiX₃

wherein:
Y represents an organo functional group selected from —NH₂, CH₂═CH—, CH₂═C(CH₃)COO—, 2,3-epoxypropoxy, HS— and, Cl—
X represents a silicon functional group selected from —OR, —OC(═O)R′, —Cl wherein R and R′ are independently selected from C₁ to C₄ alkyl, preferably —CH₃, and —C₂H₅; and
n is an integer between 0 and 10, preferably from 0 to 10 and most preferably from 0 to 3

A further advantageous embodiment of the invention is given with reference to FIG. 3B, in which the wiper arm 10 of FIG. 3A is shown in cross-section, but wherein the wiper arm 10 is further provided with a spoiler 300. Preferably, the spoiler 300 is made out of the same material as the matrix 20 and is produced during the same extraction moulding process that forms the matrix 20 around the structural member 18. The function of the spoiler 300 is to push the wiper arm 10 against a windshield of a car when the car is moving.

It has already been mentioned above that the structural member 18 can have different designs and that a varying number of structural members may be provided in the wiper arm. Some examples, which are by no means exhaustive, are given with reference to FIGS. 5A to 5P. All FIGS. 5A to 5P show the matrix 20 comprising a single or more structural members 18 of different design. It is noted that although the matrix 20 has a substantial rectangular cross-section, this is by no means meant to be limiting, rather many different cross-sectional shapes are possible without diverting from the inventive concept.

FIGS. 5A-5E for example show that the structural member(s) 18 may be in the form of a sheet, in particular a sheet metal, and that different orientations of the structural member(s) 18 are possible. FIGS. 5F and 5G show a combination of a structural member having circular and a rectangular cross-section respectively. FIG. 5H shows the use of the differently orientated sheets. FIG. 5L shows the use of a single structural member having a circular cross-section. FIGS. 5I, 5M, 5N and 5O show the use of structural members having a profiled cross-section.

FIGS. 5J, 5K and 5P show the use of at least one structural member that is shaped as a tubular member. The use of a structural member having a tubular cross-section allows it to be used to transport a cleaning fluid, i.e. a water-cleaning agent solution, to the wiper and/or to the windshield. Furthermore, the use of a structural member having a tubular cross-section will further reduce weight.

It is noted that although the invention has been described in the exemplary application of a wiper arm for a windshield wiper, the invention is not limited to that application. In fact, many applications in which normally composite materials would be used to reinforce the structure such materials are embedded in are conceivable.

1. A wiper arm (10) for a windshield wiper (100), comprising
a first end section (12) arranged to be coupled to a drive shaft of a driving means for driving the wiper arm (10);
a second end section (14) arranged to be coupled to a wiper blade (230), and
an elongate intermediate section (16) extending between said first end section (12) and said second end section (14), said intermediate section (16) comprising a structural member (18) embedded in a matrix material (20),
characterized in that
said structural member (18) consists of a single high-tensile strength material with a tensile strength exceeding 1000 MPa.

2. Wiper arm (10) according to claim 1, wherein the intermediate section (16) comprises one or two (18) each consisting of said single high-tensile strength material.

3. Wiper arm (10) according to claim 1, wherein the high-tensile strength material is chosen from a group of materials having a tensile strength of larger than 1500 MPa, more in particular more than 1800 MPa.

4. Wiper arm (10) according to claim 1, wherein the high-tensile strength material is a high-tensile steel composition.

5. Wiper arm (10) according to claim 1, wherein the structural member (18) is in the form of a wire.

6. Wiper arm (10) according to claim 1, wherein the structural member (18) is in the form of a sheet.

7. Wiper arm (10) according to claim 1, wherein the structural member (18) is in the form of a tubular member.

8. Wiper (10) according to claim 7, wherein the structural member (18) is adapted to be connected to supply means for supplying cleaning fluid.

9. Wiper arm according to claim 1, wherein the structural member (18) is provided with an anti-corrosion coating material.

10. Wiper arm (10) according to claim 8, wherein the anti-corrosion coating comprises a metal chosen from a group consisting of zinc (Zn), zinc-aluminium (ZnAl), zinc-aluminium-magnesium (ZnAlMg).

11. Wiper arm (10) according to claim 1, wherein the matrix material (20) comprises a plastic material, in particular a thermoplastic material.

12. Wiper arm (10) according to claim 10, wherein the structural member (18) is provided with a primer contacting the matrix material (20), the primer being chosen from the group consisting of organo functional silanes, organo functional titanates and organo functional zirconates.

13. Wiper arm (10) according to claim 12, wherein the primer is chosen from a group of compounds having the chemical structure:
Y—(CH₂)ₙ—SiX₃
wherein:
Y represents an organo functional group selected from —NH₂, CH₂═CH—, CH₂═C(CH₃)COO—, 2,3-epoxypropoxy, HS— and, Cl—,
X represents a silicon functional group selected from —OR, —OC(═O)R′, —Cl wherein R and R′ are independently selected from C₁ to C₄ alkyl, preferably —CH₃, and —C₂H₅; and
n is an integer between 0 and 10, preferably from 0 to 3.

14. Wiper arm (10) according to claim 1, wherein the matrix material (20) is provided by extrusion moulding around the structural member.

15. Wiper arm (10) according to claim 1, wherein the wiper arm (10) further comprises a spoiler (300) integral with the matrix (20).

16. Windshield wiper (100) comprising a wiper arm (10) according to claim 1.

17. Method of making a wiper arm (10) for a windshield wiper (100), comprising:
providing a structural member (18) consisting of a single high-tensile strength material, and
surrounding the structural member (18) by a matrix (20) of a plastic material, in particular a thermoplastic material.
